(19) United States
(12) Patent Application Publication
(10) Pub. No.: US 2020/0033070 A1
(43) Pub. Date: Jan. 30, 2020

(54) MINIMAL SURFACE HEAT EXCHANGER

(71) Applicants: Andreas Vlahinos, Castle Rock, CO (US); Maiki Vlahinos, Fort Collins, CO (US)

(72) Inventors: Andreas Vlahinos, Castle Rock, CO (US); Maiki Vlahinos, Fort Collins, CO (US)

(21) Appl. No.: 16/044,890

(22) Filed: Jul. 25, 2018

(51) Int. Cl. F28F 7/02; F28F 9/22; F28F 13/12; B01F 5/06

(52) U.S. Cl. CPC F28F 7/02; F28F 9/22; B01F 2005/0088; B01F 5/0606; F28F 13/12

(57) ABSTRACT

A heat exchanger including an enclosure and a minimal surface structure within the enclosure. The enclosure including a first inlet, a first outlet, a second inlet, and a second outlet. The minimal surface structure separating a first volume and a second volume within the enclosure. The first inlet and the first outlet being in fluid communication with the first volume, and the second inlet and a second outlet being in fluid communication with the second volume. The first and second volumes separated from mixing with each other.

### TECHNICAL FIELD

The present disclosure relates generally to heat exchangers, and, more specifically, heat exchangers utilizing a minimal surface structure to facilitate efficient heat transfer.

### BACKGROUND

A heat exchanger is a device that transfers heat from one medium to another (i.e. fluid to fluid). Typically, the mediums are separated by a solid wall to prevent mixing. Heat exchangers are widely used in space heating, refrigeration, air conditioning, power stations, chemical plants, petrochemical plants, petroleum refineries, natural-gas processing, and sewage treatment, among others. Within industrial plants and factories, heat exchangers are required to keep machinery, chemicals, water, gases, and other substances within a safe operating temperature. Examples of a heat exchanger are the home furnace, the automobile radiator and the computer heat sink. Heat-Recovery Ventilation Systems or recuperators are energy recovery heat exchangers positioned within the supply and exhaust air streams of an air handling system, or in the exhaust gases of an industrial process, in order to recover and utilize otherwise wasted heat. For example, in winter, heat is transferred from the warm exhaust air stream leaving the building to the cold fresh air stream entering the building. By recovering some of the heat that would otherwise leave the building, the recuperator increases the overall efficiency of the HVAC system.

Over the last century heat exchanger designs have improved, but the basic concepts remains the same. Amongst all types of heat exchangers, shell and tube are the most commonly used equipment. The simplest and cheapest type of shell and tube exchanger utilizes a fixed tube sheet design where the tube sheet is welded to the shell and no relative movement between the shell and tube bundle is possible. As seen in FIG. 1A (prior art), a conventional recuperator 150 includes a housing 152, a cold inlet 154, a cold outlet 156, a hot inlet 158, and a hot outlet 160. Cold fluid (indicated by the blue arrows) may enter the recuperator 150 via the cold inlet 154 and may enter small diameter piping 162 that extends through the housing 152 and ultimately out the cold fluid outlet 156. A barrier 166 separates the cold fluid entering the housing 152 from the cold fluid exiting the housing 152. The hot fluid (indicated by the red arrows) may enter the hot inlet 158 and flows through the housing 152, interacting with the piping 162 to heat the cold fluid. The hot fluid may then exit the housing 152 through the hot outlet 160. The hot fluid is prevented from mixing with the cold fluid via barrier 164 forming the inlet and outlet of the cold fluid piping 162. Baffles 168 may be included in the housing 152 to increase turbulence for the hot fluid and to uniformly distribute the flow along the length of the pipes 162. As seen in the figure, the hot and cold fluids do not mix.

Heat-Recovery Ventilation Systems or recuperators are energy recovery heat exchangers positioned within the supply and exhaust air streams of an air handling system, or in the exhaust gases of an industrial process, in order to recover and utilize otherwise wasted heat. For example, in winter, heat is transferred from the warm exhaust air stream leaving the building to the cold fresh air stream entering the building. By recovering some of the heat that would otherwise leave the building, the recuperator increases the overall efficiency of the HVAC system.

Heat exchangers are generally designed to efficiently transfer heat from a hotter fluid to a cooler fluid. One way to increase efficiency of a heat exchanger is to increase the surface area of the boundary wall between a hot and cold fluid in a two-fluid heat exchanger. Similarly, efficiency can be increased in a heat sink by increasing the surface area of the fins on a computer chip, for example.

Typically, a heat exchanger is designed to fit within a certain place within a larger overall system (e.g., building HVAC system). Because of this, increasing the surface area of a boundary wall or fin, for example, must be balanced with the space constraints of the heat exchanger within an overall system.

Accordingly, there is a need in the art for efficient heat exchangers utilizing modern design techniques and methods of manufacturing, among other advantages and needs.

### SUMMARY

Aspects of the present disclosure may involve a heat exchanger that includes an enclosure and a minimal surface structure within the enclosure. The enclosure may include a first inlet, a first outlet, a second inlet, and a second outlet. The minimal surface structure may separate a first volume and a second volume within the enclosure. The first inlet and the first outlet may be in fluid communication with the first volume, the second inlet and a second outlet in fluid communication with the second volume, and the first and second volumes may be separated from mixing with each other.

In certain instances, the minimal surface structure may include a triply periodic minimal surface structure.

In certain instances, the minimal surface structure may be a gyroid minimal surface structure, and the first and second volumes may be oppositely congruent of each other.

In certain instances, the first inlet, first volume, and first outlet are configured to receive a first fluid there through, and the second inlet, second volume, and second outlet are configured to receive a second fluid there through. The minimal surface structure may be configured to facilitate heat transfer there through between the first and second fluids.

In certain instances, the minimal surface structure may be additively manufactured.

In certain instances, the first inlet, first outlet, second inlet, and second outlet are arranged as a pair of parallel tubes with the minimal surface structure positioned at a midsection thereof.

In certain instances, the pair of parallel tubes may include a pair of parallel rectangular tubes.

In certain instances, the minimal surface structure may be arranged as a rectangular cuboid and positioned such that: a first face of the rectangular cuboid may be positioned within the first inlet; a second face of the rectangular cuboid may be positioned within the first outlet; a third face of the rectangular cuboid may be positioned within the second inlet; and a fourth face of the rectangular cuboid may be positioned within the second outlet.

In certain instances, the first inlet and first outlet are not coaxially aligned, and wherein the second inlet and the second outlet are not coaxially aligned.

In certain instances, the first inlet and second outlet are positioned on a first side of the enclosure, and the first outlet and the second inlet are positioned on a second side of the enclosure that may be opposite the first side.

In certain instances, the first inlet may be coaxially aligned with the second inlet, and the second outlet may be coaxially aligned with the first outlet.

In certain instances, the first volume extends laterally across the enclosure from the first inlet at the first side to the first outlet at the second side, and the second volume extends laterally across the enclosure from the second inlet at the second side to the second outlet at the first side.

In certain instances, the minimal surface structure may include a surface texture to increase turbulent fluid flow through the first and second volumes.

In certain instances, the surface texture may include at least one of surface protrusions and surface indentations.

In certain instances, the heat exchanger may further include a first baffle, a second baffle, a third baffle, and a fourth baffle. The first baffle may be positioned at the first inlet and proximate the minimal surface structure. The first baffle may include first openings permitting fluid flow into the first volume from the first inlet. The second baffle may be positioned at the first outlet and proximate the minimal surface structure. The second baffle may include second openings permitting fluid flow from the first volume to the first outlet. The third baffle may be positioned at the second inlet and proximate the minimal surface structure. The third baffle may include third openings permitting fluid flow into the second volume from the second inlet. The fourth baffle may be positioned at the second outlet and proximate the minimal surface structure. The fourth baffle may include fourth openings permitting fluid flow from the second volume to the second outlet.

In certain instances, the first baffle may further include a first wall portion configured to prevent fluid flow from entering the second volume from the first inlet, the second baffle may further include a second wall portion configured to prevent fluid flow from exiting the second volume into the first outlet, the third baffle may further include a third wall portion configured to prevent fluid flow from entering the first volume from the second inlet, and the fourth baffle may further include a fourth wall portion configured to prevent fluid flow from exiting the first volume into the second outlet.

In certain instances, the first baffle, the second baffle, the third baffle, and the fourth baffle may be additively manufactured.

Aspects of the present disclosure may involve a mixing chamber that includes an enclosure and a minimal surface structure positioned within the enclosure. The enclosure may include a first inlet, a second inlet, and a first outlet. The minimal surface structure may be positioned within the enclosure and positioned at least partially within the first inlet, the second inlet, and the second outlet.

In certain instances, the first inlet, second inlet, and first outlet may be tubular structures.

In certain instances, the minimal surface structure may include a Y-shape.

In certain instances, the minimal surface structure may include a gyroid minimal surface structure.

In certain instances, the gyroid minimal surface structure may be additively manufactured.

In certain instances, a first fluid may be configured to be received in the first inlet, a second fluid may be configured to be received in the second inlet, and the minimal surface structure may be configured to facilitate mixing of the first and second fluids.

### BRIEF DESCRIPTION OF THE DRAWINGS

The application file contains at least one drawing executed in color. Copies of this patent application publication with color drawing(s) will be provided by the Office upon request and payment of the necessary fee.

Example embodiments are illustrated in referenced figures of the drawings. It is intended that the embodiments and figures disclosed herein are to be considered illustrative rather than limiting.

FIG. 1A is a cross-sectional side view of a conventional shell and tube heat exchanger.

FIG. 1B is a side view of a soap film expanding between two circular wires.

FIG. 1C is a graph of a catenoid minimal surface.

FIG. 2A is an isometric view of a unit cell of the Schwarz P primitive minimal surface.

FIG. 2B is an isometric view of the Schwarz P primitive minimal surface with eight cells in a lattice configuration.

FIG. 3A is an isometric view of a diamond minimal surface of a Schwarz D lattice surface.

FIG. 3B is an isometric view of a gyroid minimal surface with a gyroid lattice surface.

FIG. 4A is an isometric view of a plane with a gyroid projected thereon.

FIG. 4B is an isometric sectional view of a gyroid with a plane near the top thereof.

FIG. 5A is a side view of a gyroid minimal surface formed in the shape of a cube having six sides of equal length.

FIG. 5B is an isometric view of the gyroid minimal surface of FIG. 5A.

FIG. 6A is an isometric view of a gyroid minimal surface with a thickness formed within an enclosure.

FIG. 6B is an isometric view of a first volume formed by the gyroid minimal surface of FIG. 6A.

FIG. 6C is an isometric view of a second and separate volume formed by the gyroid minimal surface of FIG. 6A.

FIG. 7A is an isometric view of a gyroid minimal surface.

FIG. 7B is an isometric view of two separate, intermingling volumes formed by the gyroid minimal surface of FIG. 7A.

FIG. 8A is an isometric view of a heat exchanger.

FIG. 8B is an isometric view of the heat exchanger of FIG. 8A with the side wall removed to show the inner volumes.

FIG. 9A is an isometric view of a cross-flow heat exchanger having a hexagonal housing.

FIG. 9B is a cross-sectional isometric view of the cross-flow heat exchanger with the section-line taken along a length of the heat exchanger so as to show a portion of the gyroid minimal surface structure and a baffle.

FIG. 9C is an isometric view of the gyroid minimal surface structure and a baffle of the cross-flow heat exchanger.

FIG. 10A is an isometric view of a catalytic converter.

FIG. 10B is an isometric view of a catalyst.

FIG. 100 is a front view of the catalyst.

FIG. 11A is an isometric view of a pair of batteries sandwiching a heat sink.

FIG. 11B is a front view of the heat sink.

FIG. 12 is a flowchart illustrating example steps of manufacturing a heat exchanger, heat sink, or recuperator.

FIG. 13A is a front isometric view of a second or back side of an HVAC recuperator.

FIG. 13B is a front view of a first or front side of the HVAC recuperator.

FIGS. 13C-13E are isometric, cross-sectional views of the HVAC recuperator with the cross-section taken at various depths.

FIG. 13F is a top isometric view of a volume of cold fluid flowing through the recuperator.

FIG. 13G is a top isometric view of a volume of hot fluid flowing through the recuperator.

FIG. 13H is an isometric view of the two fluid volumes of hot and cold fluid intermingling with each other (but not mixing) as they flow through the recuperator.

FIG. 14A is an isometric front view of a mixing chamber with a gyroid minimal surface structure positioned therein where the Y-shaped pipe is shown in cross-section.

FIG. 14B is a front view of the mixing chamber with the gyroid minimal surface structure positioned therein where the Y-shaped pipe is shown in cross-section.

FIG. 15 is an isometric view of a gyroid minimal surface structure showing an example of a close-up view of an engineered surface texture including a close-up view of a single surface protrusion.

FIG. 16A is an isometric view of a gyroid minimal surface structure showing another exemplary engineered surface texture.

FIG. 16B is a top view of the gyroid minimal surface structure of FIG. 16A showing the exemplary engineered surface texture.

### DETAILED DESCRIPTION

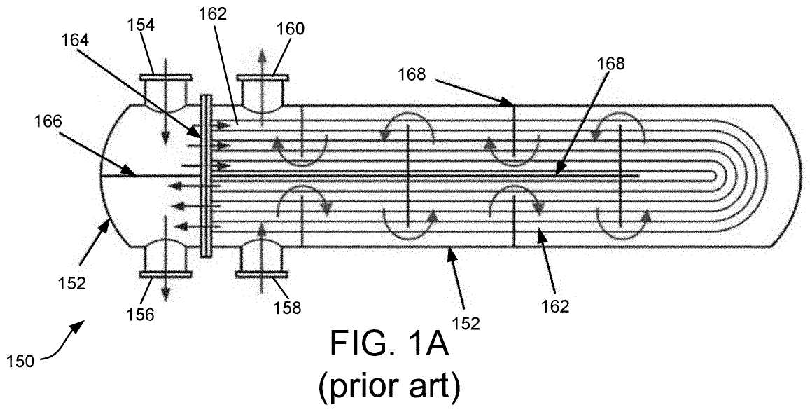

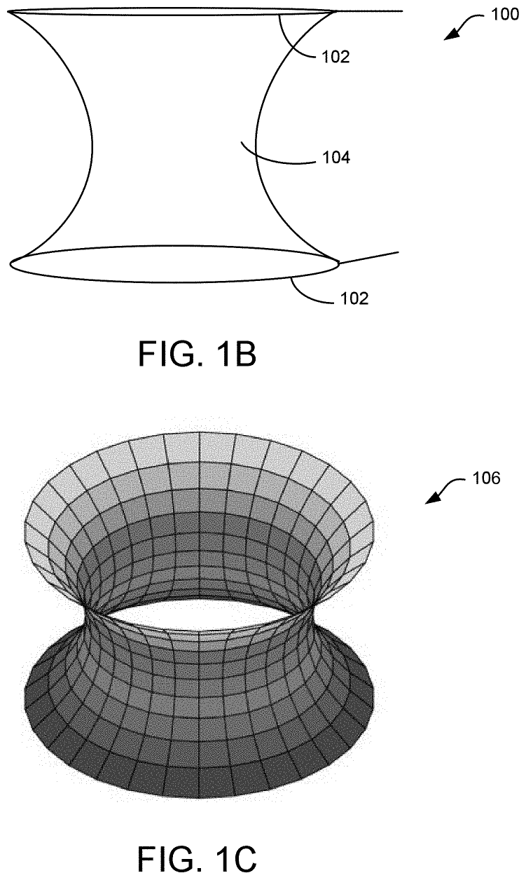

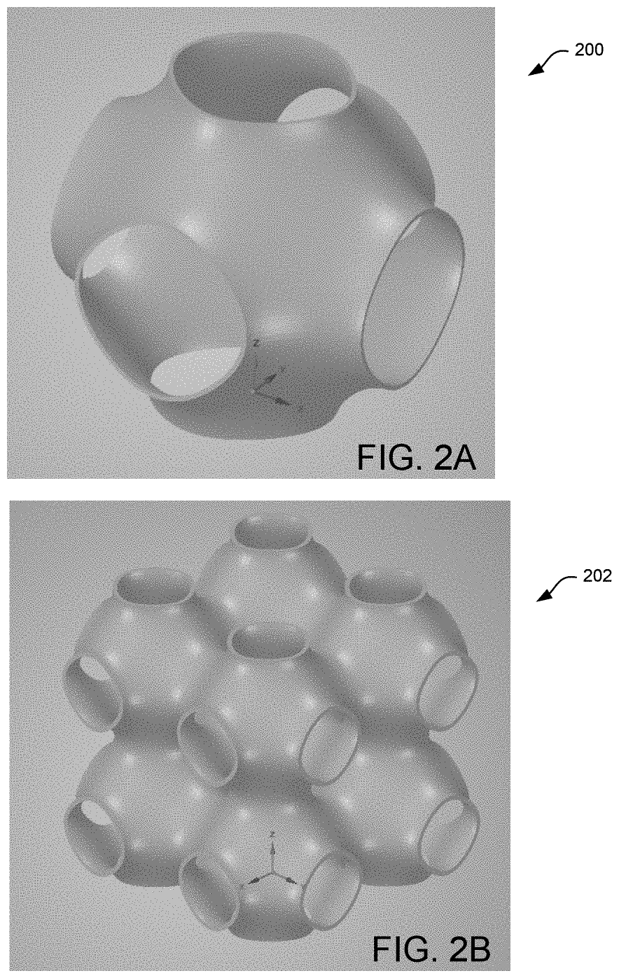

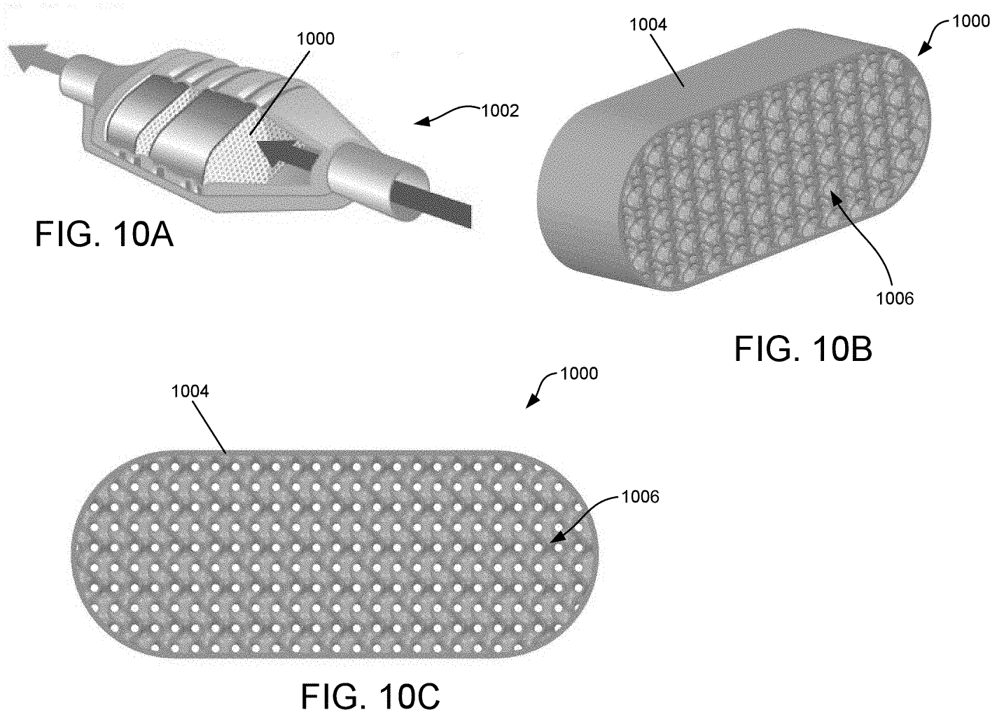

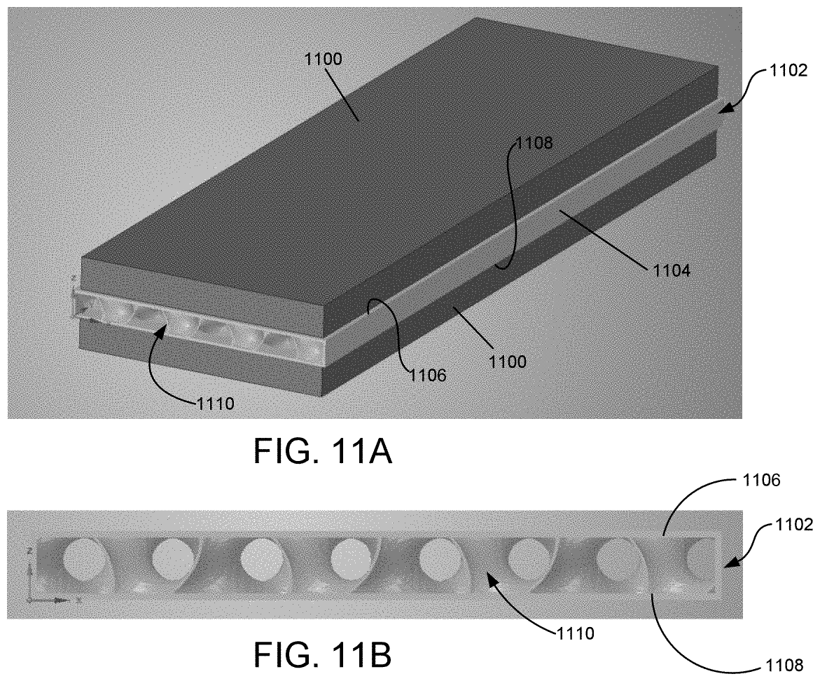

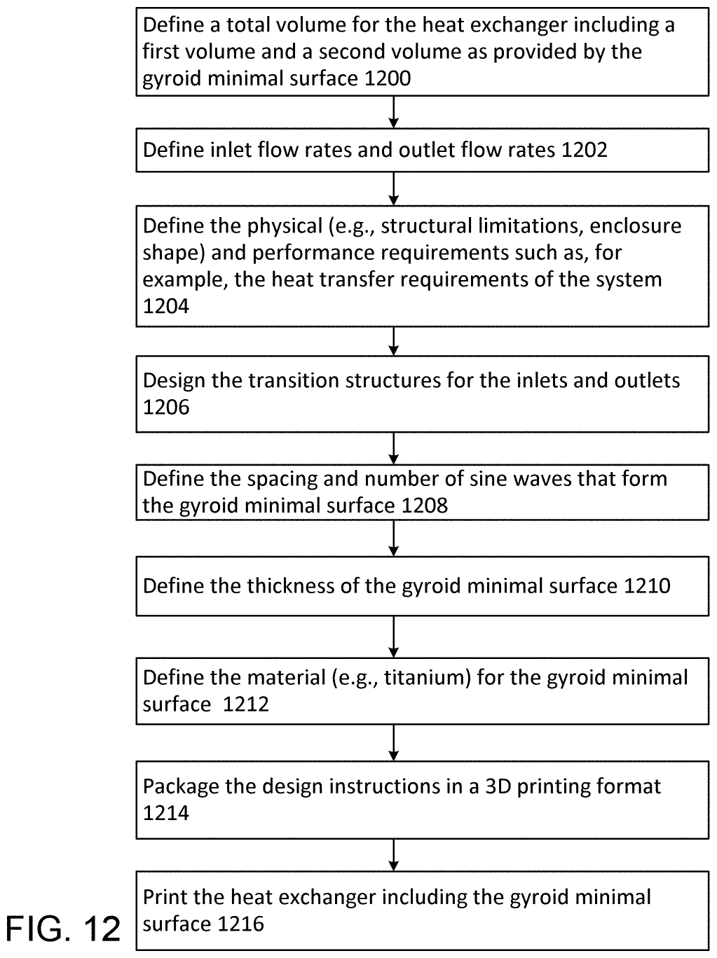

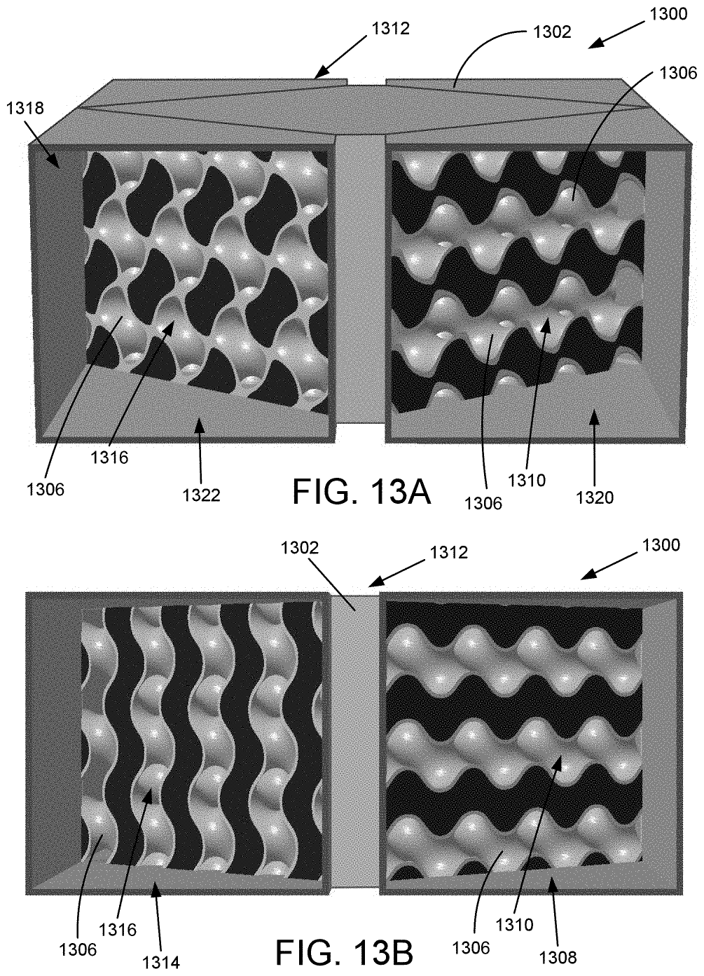

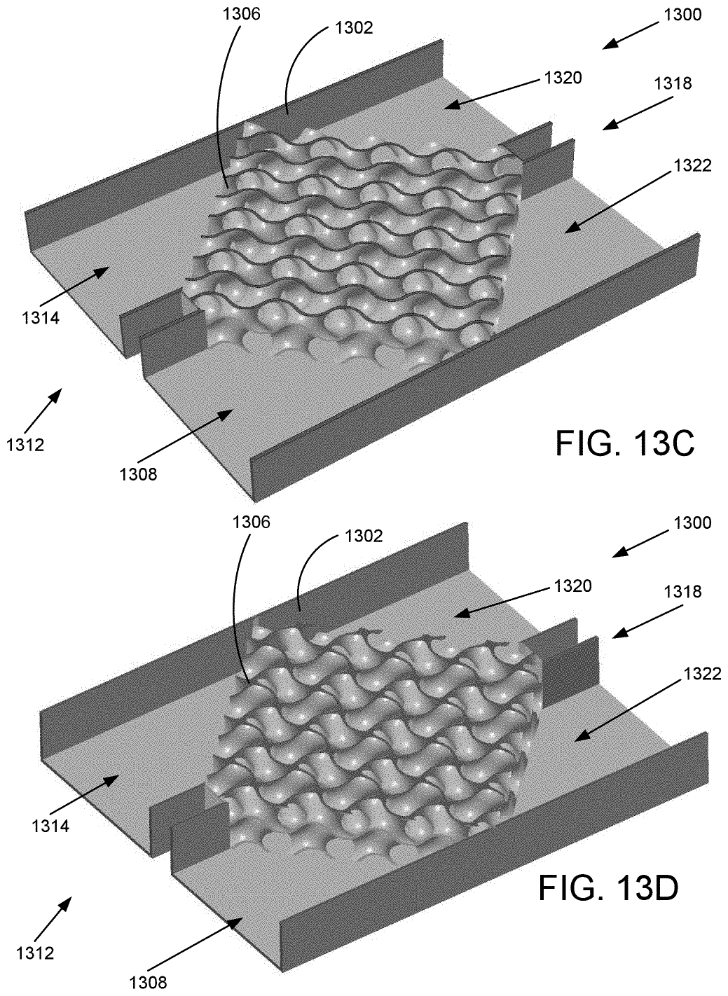

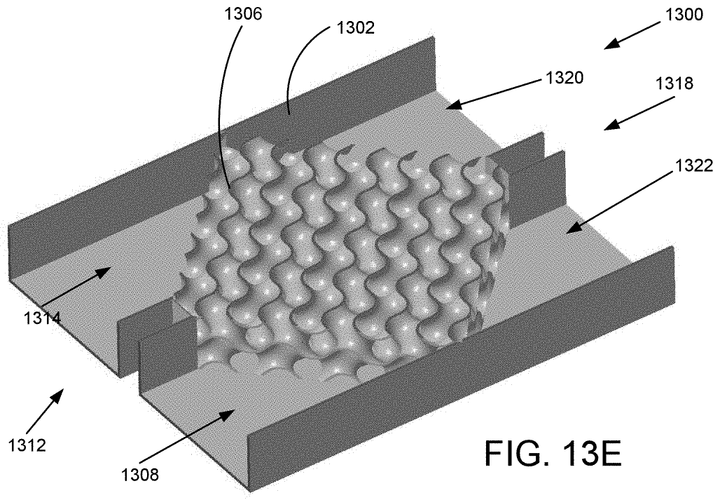

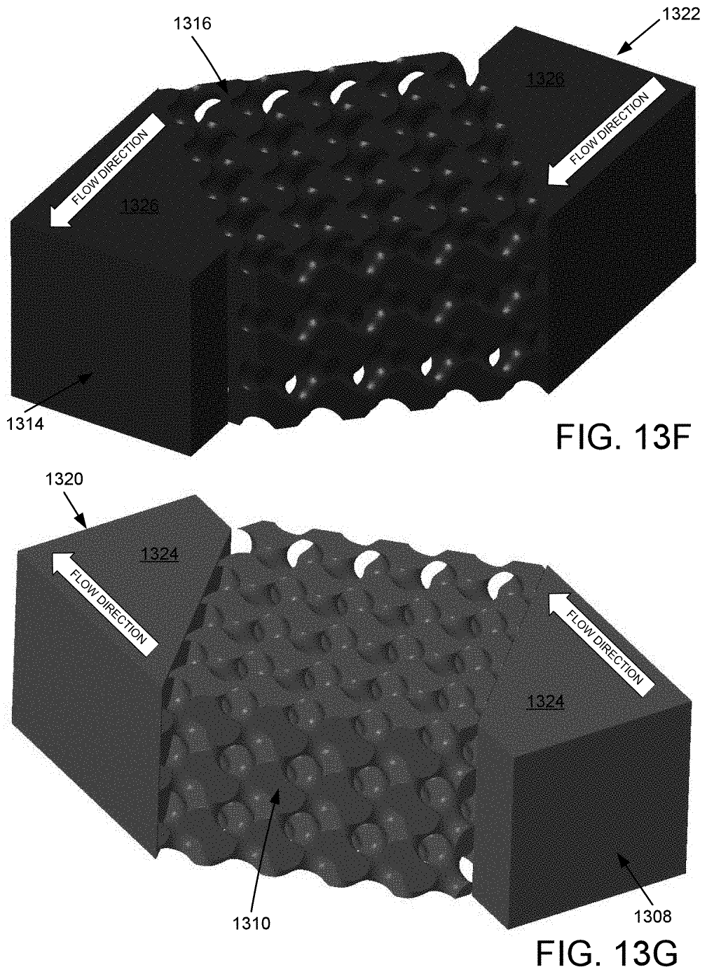

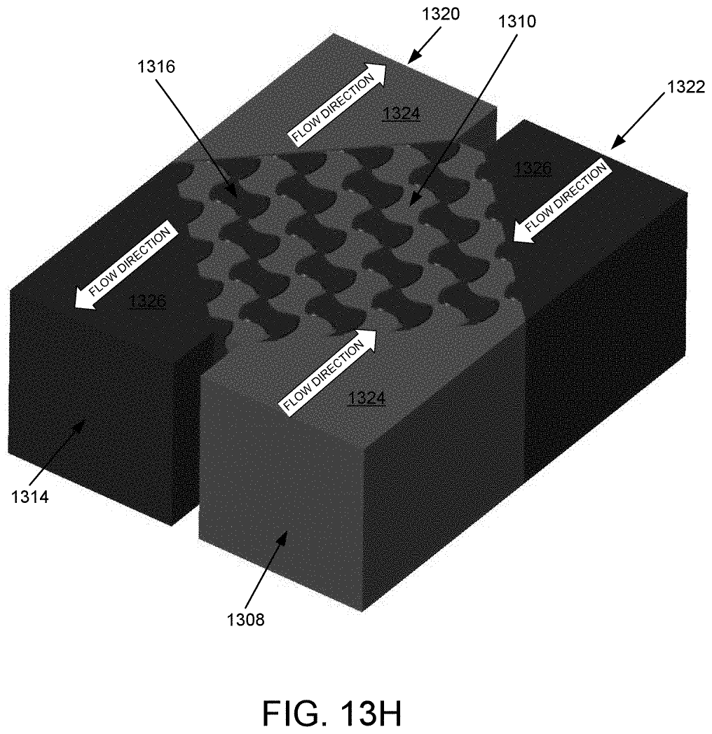

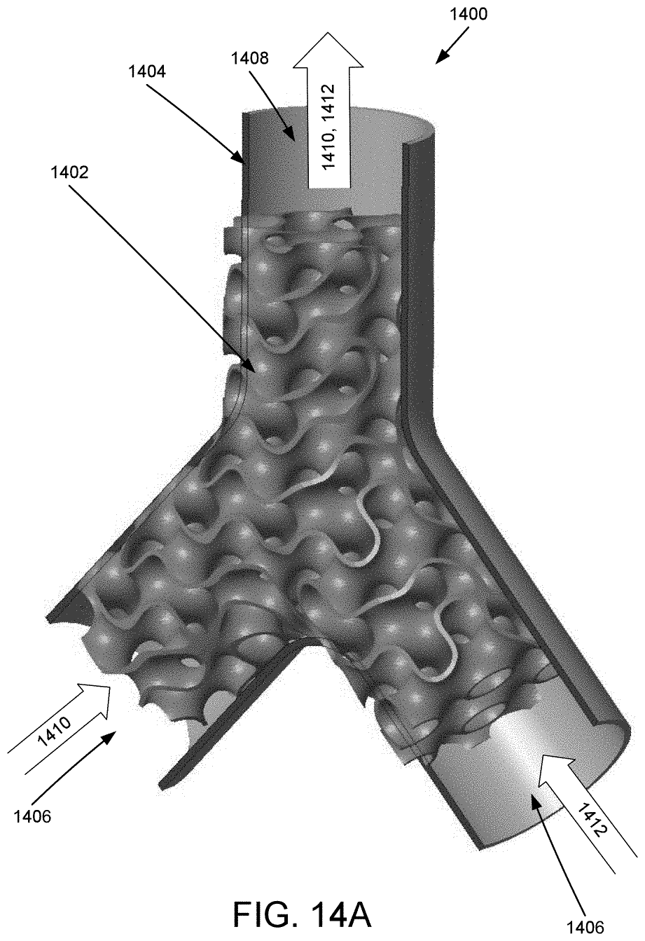

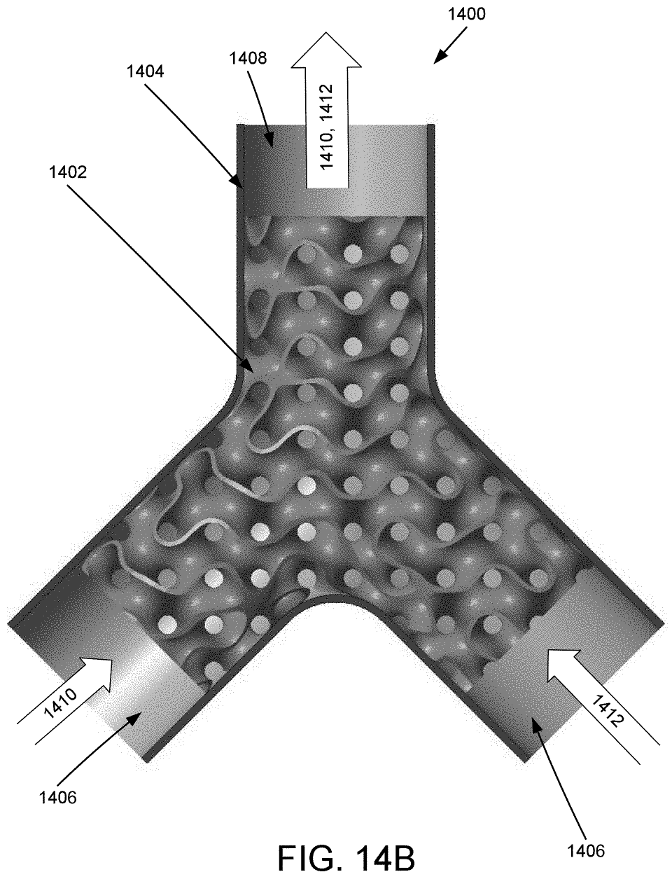

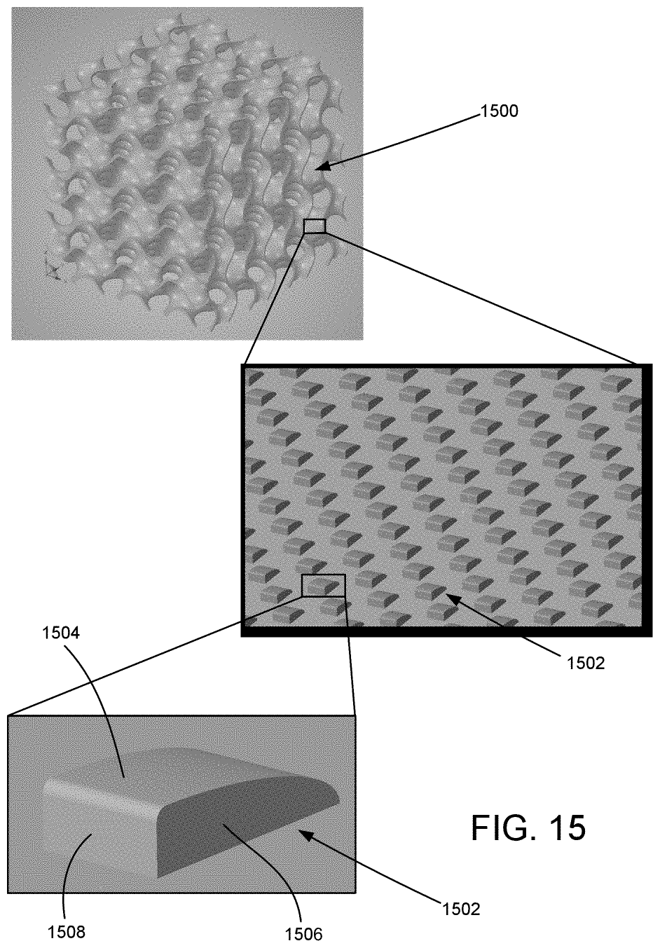

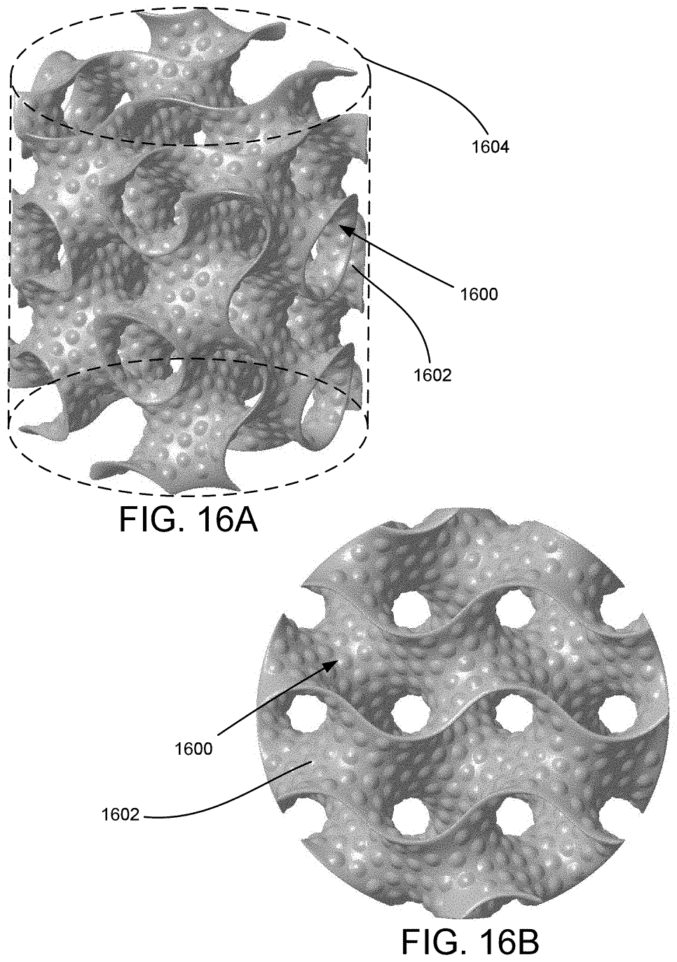

Aspects of the present disclosure involve efficient heat exchangers that maximize the surface area while minimizing material and space of a boundary structure between fluids. More particularly, heat exchangers utilizing a minimal surface structure as a boundary structure between hot and cold fluids so as to facilitate heat transfer between the fluids are disclosed herein. A minimal surface is a surface that minimizes its area within a given locality. Stated differently, a minimal surface is a surface profile with a minimum surface area given a boundary constraint. A simple example of a minimal surface constrained by four coplanar lines is a plane because a plane is the minimum surface area that is needed to span between the four coplanar lines. A more informative example of minimal surfaces occurring in physical form involves the formation and morphing of soap bubbles. As seen in FIG. 1B, which is a side view of a soap film 100 expanding between two circular wires 102, the soap film 100 necks inward at the midsection 104 between the two circular wires 102. When bounded by the closed spaces of the wires 102, the soap film takes on the minimal surface of a catenoid 106, which is shown in FIG. 10. The catenoid 106 is a surface-type in topology formed by rotating a catenary curve about a central or longitudinal axis. An example of a catenary curve is the shape of an electrical power line hanging between two telephone poles. The catenary curve is not a parabolic function, but a hyperbolic cosine function.

As another example, a minimal surface with six orthogonally oriented circles as constraints yields the minimal surface 200 shown in FIG. 2B. Because the minimal surface in FIG. 2A is triply periodic one could connect (in all directions X, Y, Z) these individual units to form a surface lattice structure as seen in FIG. 2A. By connecting eight units together a 4×4 lattice structure of the primitive minimal surface 202 is shown in FIG. 2B. This primitive minimal surface 202 is called a Schwarz P surface Lattice structure, which is one type of triply periodic minimal surface (TPMS). TPMS is a minimal surface that repeats itself in three dimensions. The Schwarz P may be functionally expressed as: cos(x)+cos(y)+cos(z)=0.

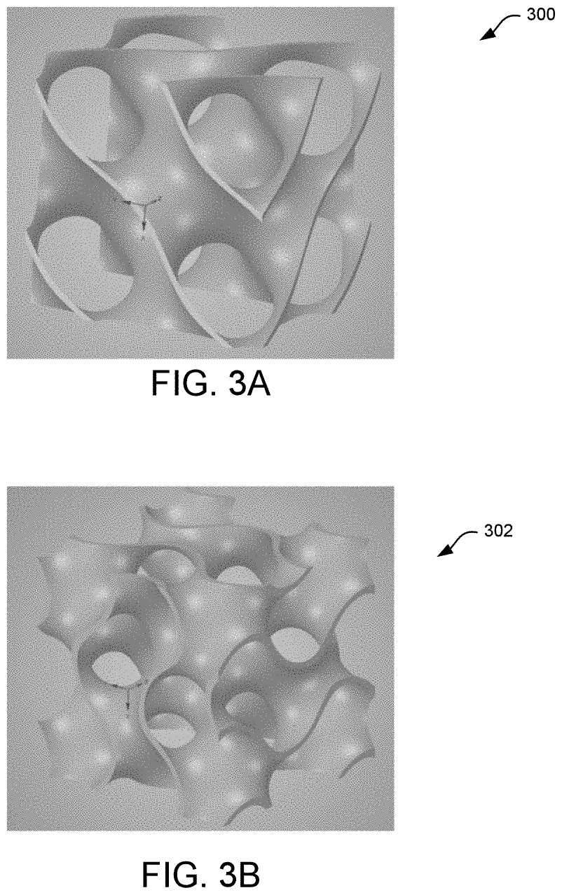

Another type of TPMS, shown in FIG. 3A, is a diamond minimal surface 300 with a Schwarz D surface Lattice structure. This particular minimal surface is called a “diamond” because it has two intertwined congruent labyrinths where each has the shape of a tubular version of a diamond bond structure. The Schwarz D may be functionally expressed as: sin(x)sin(y)sin(z)+sin(x)cos(y)cos(z)+cos(x)sin(y)cos(z)+cos(x)cos(y)sin(z)=0.

Yet another type of minimal surface, shown in FIG. 3B, is a gyroid minimal surface 302 with a Gyroid surface Lattice structure. The gyroid does not contain straight lines or planar symmetries. As will be discussed in subsequent figures, the gyroid (as with the other minimal surfaces described above) separates the entire volume into two distinct passages or volumes. The gyroid minimal surface 302 may be functionally expressed as: sin(x)cos(y)+sin(y)cos(z)+sin(z)cos(x)=0. As defined, a gyroid minimal surface 302 has a zero mean curvature. Stated differently, the minimal surface 302 has a mean curvature of zero at each point on the surface area defining the gyroid minimal surface.

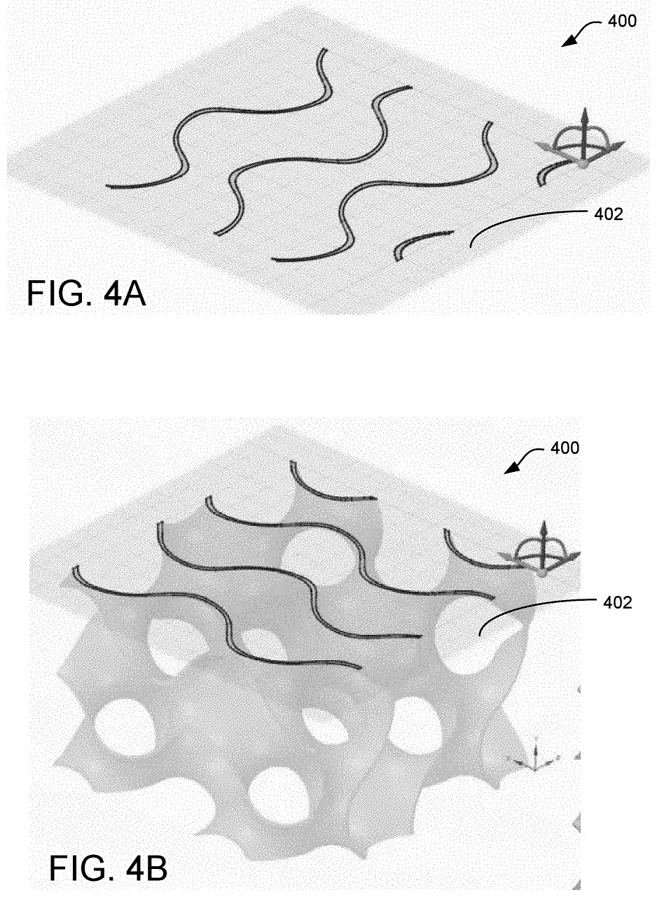

FIGS. 4A and 4B depict the formation of a gyroid minimal surface with FIG. 4A depicting a gyroid 400 projected on a plane 402, and FIG. 4B depicting a gyroid formed a distance from the plane 402. As seen in the figures, the gyroid is formed of rotating and intersecting waves that resemble sine waves going in orthogonal directions as the gyroid extends upward.

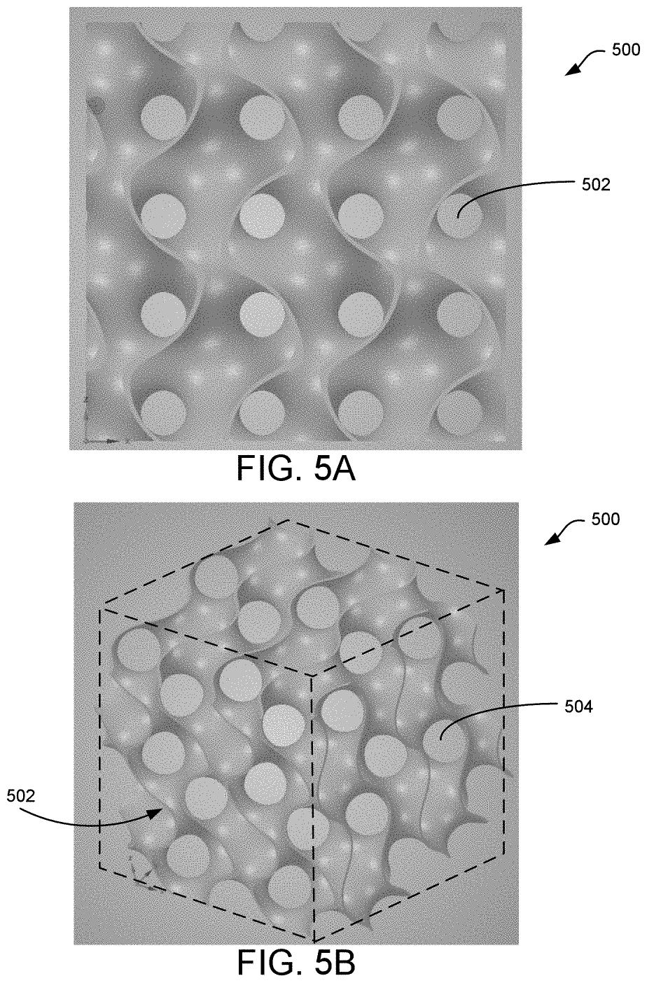

FIG. 5A depicts a side view of a gyroid minimal surface structure 500 formed in the shape of a cube having six sides of equal length. The gyroid minimal surface structure 500 includes a pair of curvate outer surfaces separated by a thickness defined by the creation of the gyroid. Each of the pair of curvate outer surfaces has a surface area having a mean curvature of zero at all points. As seen in the figure, the gyroid minimal surface structure 500 defines a plurality of passageways 502 extending longitudinally through each of the six faces or sides of the gyroid minimal surface structure. The plurality of passageways 502 are generally parallel with each other. FIG. 5B depicts a near isometric view of the gyroid minimal surface structure 500. As seen in the figure, the gyroid minimal surface structure 500 defines another plurality of passageways 504 extending across the gyroid minimal surface structure 500 at a non-orthogonal angle to the other plurality of passageways 502.

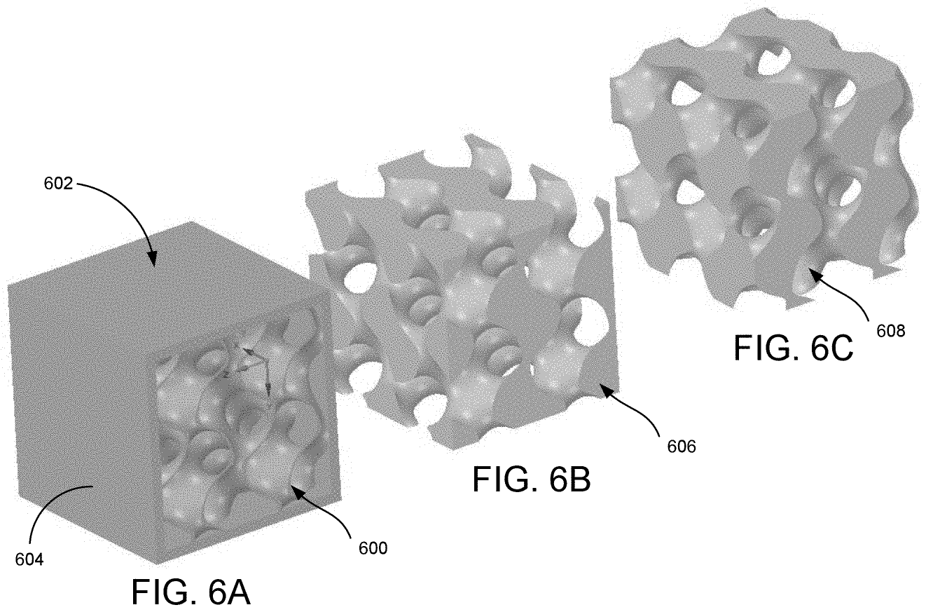

In contrast to the gyroid minimal surface structure 500 in FIGS. 5A and 5B, which is not enclosed or bounded, the gyroid minimal surface structure 600 of FIG. 6A is formed within an enclosure 602. The enclosure 602 is formed by planar boundary surfaces 604 on four sides or faces of the cube (i.e., there are two open faces in order to show the gyroid minimal surface structure therein, and to provide a fluid path through the enclosure 602). That is, the gyroid minimal surface structure 600 extends to all the side surfaces 604 such that the gyroid minimal surface structure 600 defines two distinct passages that are negative images/volumes of each other. Stated another way, the gyroid minimal surface structure 600 defines two oppositely congruent passages or volumes separated by the gyroid minimal surface 600, and separated by the boundary surfaces 604 on the sides.

FIG. 6B depicts a first volume 606 defined by the gyroid minimal surface structure 600 of FIG. 6A, and FIG. 6C depicts a second volume 608 defined by the gyroid minimal surface structure 600 of FIG. 6A. The first volume 606, the gyroid minimal surface structure 600, and the second volume 608 intermingle to form a near continuous volumetric cube. The void space defined by the first volume 606 of FIG. 6B defines the second volume 608 of FIG. 6C (assuming the gyroid minimal surface structure 600 is of a small or nearly negligible thickness). When the gyroid minimal surface structure 600 is formed, the first and second volumes 606, 608 are bifurcated and do not mix. The first and second volumes 606, 608 may define the same or similar sized volumes depending on how the gyroid minimal surface structure 600 is defined.

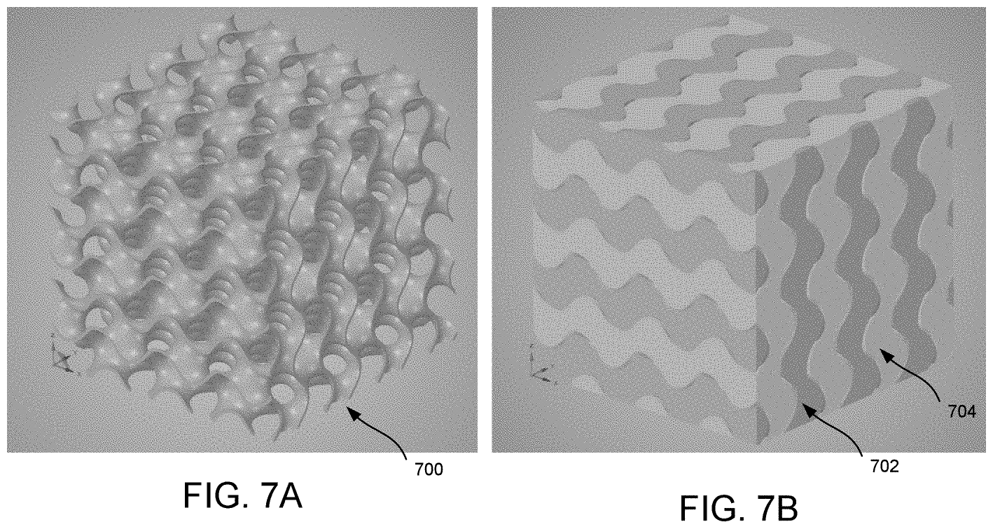

FIG. 7A depicts an isometric view of a gyroid minimal surface structure 700 (bounded by six sides or faces of equal size, where the six sides are not shown), and FIG. 7B depicts an isometric view of a first volume 702 (colored orange) and a second volume 704 (colored blue) formed by “filling” the void spaces in the gyroid minimal surface structure 700, assuming the first and second volumes 702, 704 do not extend beyond the boundary of the six planar sides or faces. The first volume 702 defines a passageway that is independent of the second volume 704 because at all points the volumes 702, 704 are separated from each other by the gyroid minimal surface structure 700. In this way, the first and second volumes 702, 704 do not mix. FIG. 7B illustrates the intermeshed nature of the first and second volumes 702, 704, and how the volumes are oppositely congruent or negative image volumes of each other. The gyroid minimal surface structure 700 is not shown in FIG. 7B; thus, there can be seen a small gap between the first and second volumes 702, 704.

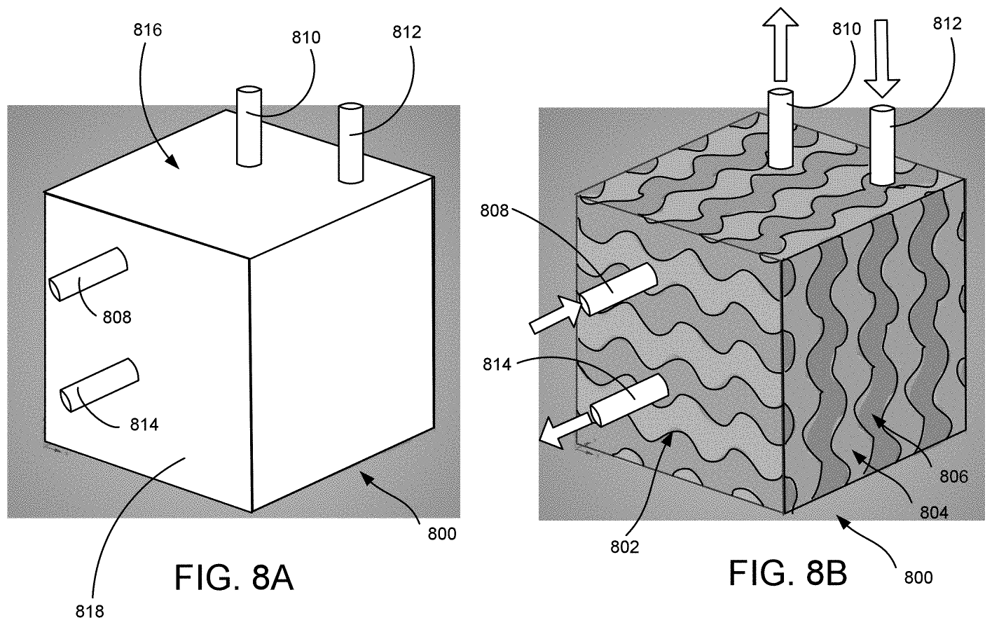

Using the configuration from FIGS. 7A and 7B as an example, FIG. 8A depicts an isometric view of a heat exchanger 800 including a housing or enclosure 816 having six planar side surfaces 818, a first inlet 808, a first outlet 810, a second inlet 812, and a second outlet 814. FIG. 8B depicts an isometric view of the heat exchanger 800 of FIG. 8A, except with the six planar side surfaces 818 of the housing 816 removed to show the inner elements of the heat exchanger 800. As seen in FIG. 8B, the heat exchanger 800 additionally includes a gyroid minimal surface structure 802 separating a first volume 804 and a second volume 806. The first inlet 808 may receive a first fluid into the first volume 804 (colored orange), and the first outlet 810 may outlet the first fluid from the first volume 804. The second inlet 812 may receive a second fluid into the second volume 806 (colored blue), and the second outlet 814 may output the second fluid from the second volume 806. The first and second inlets 808, 812 and the first and second outlets 810, 814 may be conduits connected to their respective volumes 804, 806 so as to provide fluid communication therethrough.

Since the first and second volumes 804, 806 are separate from each other, there is no mixing of the first and second fluids. Thus, the first fluid enters the first volume 804 via first inlet 808, and the entirety of the first fluid exits the first volume 804 via the first outlet 810 without mixing with the second fluid. Similarly, the second fluid enters the second volume 806 via the second inlet 812, and the entirety of the second fluid exits the second volume 806 via the second outlet 814 without mixing with the second fluid.

The heat exchanger 800 operates to transfer heat between the first and second fluids by the movement of energy from the hotter of the two fluids to the cooler of the two fluids. The gyroid minimal surface structure 802 is the boundary between the two fluids and, thus, the heat transfer occurs across the boundary wall of the gyroid minimal surface structure 802.

While FIGS. 8A and 8B illustrate a single inlet and outlet for each volume, there may be multiple inlets and outlets throughout the volumes in order to evenly distribute the incoming and outgoing flows of fluid, as will be described subsequently. As such, the embodiments depicted and described herein are illustrative in nature and not intended to be limiting. Additionally or alternatively, the inlets and outlets may include a transition structure that is molded or otherwise fitted to the respective inlets and outlets. The transition structures may, for example, act as a nozzle or diffuser to direct the flow of fluid into or out of a volume. A portion of the transition structure may include an extension portion of the gyroid minimal surface structure positioned within the transition structure. The extension portion of the gyroid minimal surface structure may decrease stress concentrators (e.g., high pressure areas) as the fluid flow enters or exits the heat exchanger. The extension portion may be a continuation of the shape of the gyroid minimal surface structure, or may be a modified structure that includes a part of the shape of the gyroid minimal surface structure and a part of the shape of the transition structure.

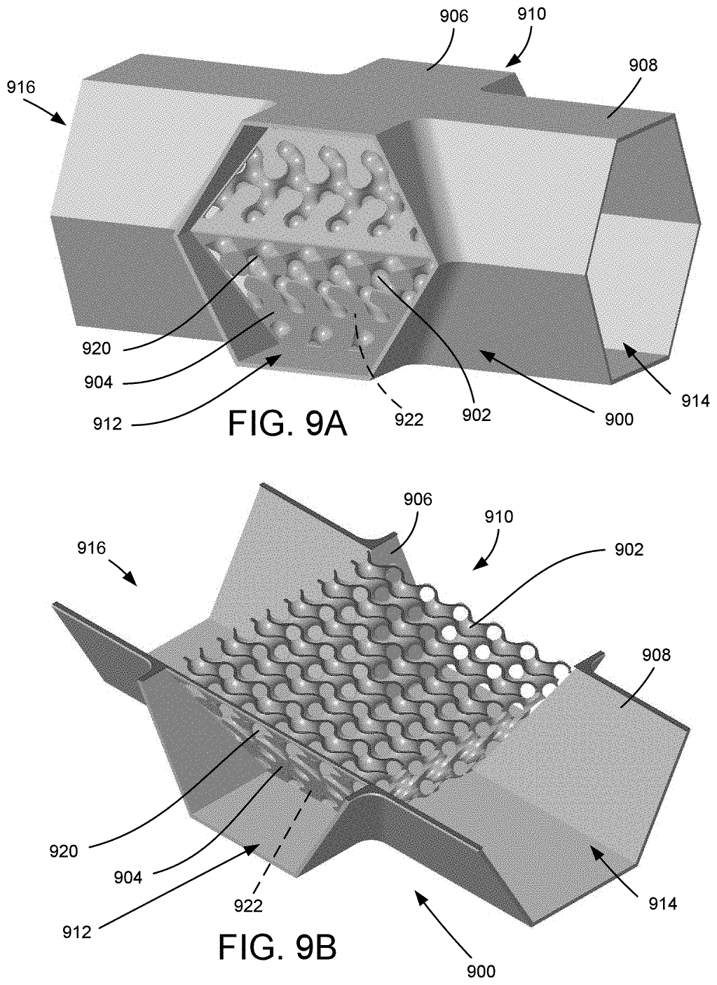

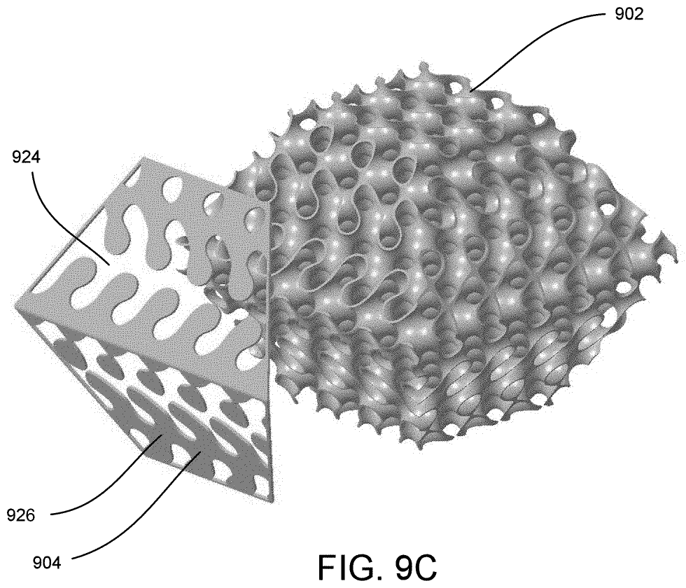

Reference is made to FIGS. 9A-9C, which depicts various views of a heat exchanger 900 with a cross-flow configuration, also called a recuperator. More particularly, FIG. 9A depicts an isometric view of the heat exchanger 900, FIG. 9B depicts an isometric cross-sectional view of the heat exchanger 900, and FIG. 9C depicts an exploded isometric view of a gyroid minimal surface structure 902 and a baffle 904 of the heat exchanger 900. As seen in FIG. 9A, the heat exchanger 900 includes two hexagonal structures 906, 908 oriented perpendicular to each other. The first hexagonal structure 906 includes an inlet 910, and an outlet 912. The second hexagonal structure 908 includes an inlet 914, and an outlet 916. The gyroid minimal surface 902 is positioned at the intersection of the two structures 906, 908. As described previously, the gyroid minimal surface structure may define two distinct passageways or volumes 920, 922.

The baffles 904 may be fitted within the inlets 910, 914 and outlets 912, 916 so as to block fluid from entering a particular volume of the gyroid minimal surface structure 902. In this particular example, there are two baffles 904 for the first hexagonal structure 906 that block fluid from entering the second volume 922 (shown in broken line in FIGS. 9A and 9B as it is blocked by the baffle 904) of the gyroid minimal surface structure while permitting fluid to enter the first volume 920. And, while not shown in FIGS. 9A and 9B, there are two baffles 904 for the second hexagonal structure 908 that block fluid from entering the first volume 920 while permitting the fluid to enter the second volume 922. The baffles 904 may be designed a continuous structure connected at a perimeter thereof. And the baffles 904 may be designed at a particular position and orientation along the formation of the gyroid minimal surface structure 902 such that no portions of the baffle 904 defines isolated “islands” or portions that are not connected to the baffle 904 as a whole. Stated differently, the baffle 904 may be designed as a unitary structure that covers an entirety of one of the volumes 920, 922 of the gyroid minimal surface structure 902. In certain instances, the baffles 904 may be 3D printed.

As seen in FIG. 9C, the baffle 904 and the gyroid minimal surface structure 902 are shown in an exploded view with the hexagonal structures 906, 908 hidden from view. As described previously, the baffles 904 (only one shown in FIG. 9C, however the heat exchanger 900 may include additional baffles 904, such as four baffles 904) may be single piece structures having a continuous perimeter. In this particular embodiment, the baffles 904 may be angled at a midpoint thereof. Additionally or alternatively, the baffles 904 may include certain angled or sloped structures to direct the flow of fluid into or out of a volume within the gyroid minimal surface structure so as to increase laminar flow into the volume. As seen in FIG. 9C, the baffle 904 includes openings 924 defined between walls 926 of the baffle 904. The openings 924 correspond to a shape of the particular volume of the gyroid minimal surface structure 902 that the fluid is desired to enter or exit. Correspondingly, the walls 926 of the baffle 904 correspond to a shape of the particular volume of the gyroid minimal surface structure 902 that the fluid from the inlet or outlet is to be blocked from entering or exiting.

The heat exchanger 900 in FIGS. 9A and 9B, among others, may be used in heating, ventilation, and air conditioning (HVAC) systems of a building that provides the interior space of the building with conditioned and treated air from fresh, cool air (fluid) from outside the building. Once the treated air is provided to the interior space of the building, the air may be exported out of the building in the form of the warm air (fluid). The heat exchanger 900 may function to pre-heat the incoming fresh, cool air (fluid) so as to raise the temperature of the air before it reaches the HVAC system's heater.

FIGS. 10A-10C depict an example implementation of a catalyst 1000 in a catalytic converter 1002. FIG. 10A depicts an isometric view of a catalytic converter 1002 with a three-way catalyst. The catalytic converter is used in automobiles to reduce the production of toxic chemicals from entering the atmosphere that result from the automobile's combustion cycle. The catalyst is conventionally made from platinum and rhodium and includes a large surface area to increase the reaction of carbon monoxide and unburnt fuel from the exhaust gases with oxygen in the air.

FIGS. 10B and 100 depict, respectively, an isometric view of a catalyst 1000, and a front view of the catalyst 1000. The catalyst 1000 includes an outer band 1004 in an obround or slot shape (i.e., the outer band 1004 has a perimeter having parallel sides and rounded ends), and a gyroid minimal surface structure 1006 within the outer band 1004. The gyroid minimal surface structure 1006 extends to all sides of the outer band 104, and includes a thickness extending substantially the thickness of the outer band 1004. The gyroid minimal surface structure 1006 may be manufactured of rhodium and platinum and used in the catalytic converter 1002 of FIG. 10A to reduce the exhausting of toxic gases into the atmosphere. This design has an order of magnitude larger surface area than a traditional extruded design.

In the context of a catalytic converter 1002, a mixture of gases flow through the catalyst 1000 in one direction. Thus, the mixture of gases may flow through both of the pair of passageways defined by the gyroid minimal surface structure 1006.

FIG. 11A depicts a pair of batteries 1100 sandwiching a heat sink 1102. The heat sink 1102 comprises an outer surface 1104 defining a rectangular cross-section. The outer surface 1104 of the heat sink 1102 includes a top and bottom surface 1106, 1108 generally matching a shape and size (i.e., surface area) of a top and bottom surface of the batteries 1100. The heat sink 1102 includes a gyroid minimal surface structure 1110 within the outer surface 1104. The gyroid minimal surface structure 1110 may permit cooling of the batteries by transferring heat from the batteries 1100 to the heat sink 1102. Ambient air (or forced air, or liquid) may flow through the gyroid minimal surface structure so as to cool the heat sink 1102, and, thus, the batteries 1100 attached thereto.

Additional applications of a gyroid minimal surface structure include, but are not limited to, structural applications, dampening applications, thermal insulation, and mixing fluids, among others. In the mixing context, any of the heat exchangers previously described may be modified to provide mixing of fluids by, for example, having multiple fluid inputs and a single fluid output, as seen in FIGS. 14A and 14B.

Producing the complex shapes and passageways associated with the gyroid structure with traditional machining and milling practices poses significant manufacturing challenges. The advent of three-dimensional (3D) printing has made producing such complex structures feasible. Conventionally, a part manufactured from 3D printing that has angles greater than forty-five degrees requires supporting structures to be included in the manufacturing to prevent the structure from collapsing or warping during the printing process. Manufacturing gyroid minimal surface structures via 3D printing is particularly advantageous as gyroid minimal surface structures as described herein include an angle of association of about thirty-eight degrees. This property permits 3D printing via a three-dimensional printing machine without the addition of supporting structures (e.g., columns, struts). Each layer of the gyroid gradually “steps out”, which makes the structure “self-supporting” during additive manufacturing.

The various heat exchangers, recuperators, heat sinks, and other devices with a gyroid minimal surface structure may be manufactured as follows and as seen in FIG. 12. Define a total volume for the heat exchanger including a first volume and a second volume as provided by the gyroid minimal surface structure 1200. Define inlet flow rates and outlet flow rates 1202. Define the physical (e.g., structural limitations, enclosure shape) and performance requirements such as, for example, the heat transfer requirements of the system 1204. Design the transition structures for the inlets and outlets 1206. Define the spacing and number of sine waves that form the gyroid minimal surface structure 1208. Define the thickness of the gyroid minimal surface structure 1210. Define the material for the gyroid minimal surface structure (e.g., titanium) 1212. Package the design instructions in a 3D printing format 1214. Print the heat exchanger including the gyroid minimal surface structure 1216. Alternatively, the gyroid minimal surface structure may be printed separately from the heat exchanger and assembled together.

Reference is made to FIGS. 13A-13H, which shows various views of a heat exchanger or recuperator 1300. To begin, reference is made to FIGS. 13A and 13B, which illustrate a front view slightly from a top thereof, and a back view of the recuperator 1300, respectively. The recuperator 1300 includes an enclosure 1302 defined by two parallel, rectangular housings or rectangular tubes connected to each other at a midsection via by a gyroid minimal surface structure 1306 that separates a first and second volume therein. As seen in FIG. 13B, the recuperator 1300 includes, at a first side 1312, a first inlet 1308 for receiving a first fluid 1324 (not shown in FIGS. 13A and 13B) into the first volume 1310. The first side 1312 may additionally include a second outlet 1314 for outputting the second fluid 1326 (not shown in FIGS. 13A and 13B) from the second volume 1316. As seen in FIG. 13B, the first inlet 1308 and the second outlet 1314 are rectangular openings in the enclosure 1302 that are parallel to each other.

As seen in 13A, the second side 1318 of the recuperator 1300 may include a first outlet 1320 for outputting the first fluid 1324 from the first volume 1310, and a second inlet 1322 for receiving the second fluid 1326 into the second volume 1316. The second inlet 1322 and the first outlet 1320 are rectangular openings in the enclosure 1302 that are parallel to each other. The blue patterns shown in FIGS. 13A and 13B may be part of a baffle for blocking a flow of fluid into a particular volume. In such a case, for example, the first fluid 1324 flowing into the first inlet 1308 may contact the baffle (shown in blue) and be prevented from entering into the second volume 1316, and caused to only flow into the first volume 1310. Baffles may be used to block fluid flow into

As seen in FIGS. 13C-13E, which are isometric, cross-sectional views of the recuperator 1300 with the cross-section taken at various depths so the curvature of the gyroid minimal surface structure 1306 can be seen at the various depths. The gyroid minimal surface structure 1306 separates the first and second volumes 1310, 1316 into discreet, non-mixing passages or volumes. That is, the first fluid 1324 may flow from the first inlet 1308, through the first volume 1310, and out the first outlet 1320 without mixing with the second fluid 1326. As seen in FIGS. 13C-13E, the first inlet 1308 and first outlet 1320 are parallel to each other, but not coaxial. That is, the gyroid minimal surface structure 1306 causes the first fluid 1324 to move laterally from the first inlet 1308 to the first outlet 1320. Similarly, the second fluid 1326 may flow from the second inlet 1322, through the second volume 1316, and out the second outlet 1314 without mixing with the first fluid 1324. As seen in FIGS. 13C-13E, the second inlet 1322 and the second outlet 1314 are parallel to each other, but not coaxial. That is, the gyroid minimal surface structure 1306 causes the second fluid 1326 to move laterally (in an opposite direction from the first fluid 1324) from the second inlet 1322 to the second outlet 1314.

As seen in FIG. 13C, the gyroid minimal surface structure 1306 is oriented to direct a flow of fluid from the second inlet 1322, across the enclosure 1302, and out the second outlet 1314. Similarly, as seen in FIG. 13E, the gyroid minimal surface structure 1306 is also oriented to direct a flow of fluid from the first inlet 1308, across the enclosure 1302, and out the first outlet 1320. FIG. 13D shows the gyroid minimal surface structure 1306 at a particular depth between that shown in FIGS. 13C and 13E.

It is noted, the gyroid minimal surface structure 1306 in this instance is manufactured in a rectangular cuboid shape with two faces defining the first inlet and first outlet 1308, 1320, respectively, and two faces defining the second inlet, and second outlet 1322, 1314, respectively. Four edges of the rectangular cuboid abut internal surfaces of the enclosure 1302 so as to restrict mixing of the fluids past the edges. Engineered flow diverters may be placed at any one of or all of the inlets 1308, 1322 and/or the outlets 1314, 1320 as the fluid transitions from the rectangular cuboid shape to the gyroid minimal surface structure 1306 in order to evenly distribute flow and prevent mixing of the volumes.

The recuperator 1300 may be used in heating, ventilation, and air conditioning (HVAC) systems of a building that provides interior space of the building with conditioned and treated air from fresh (untreated) air from outside the building. Once the treated air is provided to the interior space of the building, the air may be exported out of the building in the form of the warm air. The heat exchanger 1300 may function to pre-heat the incoming cool air or cool incoming warm air so as to raise or lower the temperature of the air before it reaches the HVAC system thereby increasing the efficiency of the entire system.

Reference is made to FIGS. 13F-13H, which shows the second volume 1316 as it passes through the enclosure 1302, the first volume 1310 as it passes through the enclosure 1302, and the first and second volumes 1310, 1316 intermeshed together as they pass through the enclosure 1302 (with the enclosure 1302 and gyroid minimal surface structure 1306 hidden from view), respectively. As seen in FIG. 13F, the second fluid 1326 is depicted as a cold fluid (blue) in the recuperator 1300. The second fluid 1326 enters the second inlet 1322, forms a second volume 1316 as it travels laterally across the enclosure 1302 (not shown) via the curvate surface of the gyroid minimal surface structure 1306 (also not shown), and exits through the second outlet 1314. Similarly, as seen in FIG. 13G, the first fluid 1324 is depicted as a hot fluid (red) in the recuperator 1300. The first fluid 1324 enters the first inlet 1308, forms a first volume 1310 as it travels laterally across the enclosure 1302 (not shown) via the curvate surface of the gyroid minimal surface structure 1306 (also not shown), and exits through the first outlet 1320.

Turning to FIG. 13H, the first and second volumes 1310, 1316 are intermeshed together such that the heat from the hot fluid 1324 is transferred efficiently through the gyroid minimal surface structure 1306 (not shown) to the cold fluid 1326. As seen in the figure, the first and second volumes 1310, 1316 are generally negative images of each other. While the arrangement of the recuperator 1300 includes a cross-flow pattern for the hot and cold fluids, the recuperator 1300 may be designed such that the hot and cold fluids travel in the same direction without limitation.

Reference is made to FIGS. 14A and 14B, which depict an exemplary mixing chamber 1400 having a gyroid minimal surface structure 1402 to facilitate uniform mixing. FIG. 14A depicts an isometric view of the gyroid minimal surface structure 1402 within a cross-sectioned pipe 1404. FIG. 14B depicts a side view of the gyroid minimal surface structure 1402 within the cross-sectioned pipe 1404. As seen in the figures, the pipe 1404 includes two inlets 1406 and an outlet 1408. A first fluid 1410 may enter a first inlet 1406 and a second fluid 1412 may enter a second inlet 1406. The gyroid minimal surface structure 1402 may extend into each of the inlets 1406 and may permit the first and second fluids 1410, 1412 to mix within the confines of the gyroid minimal surface structure 1402. That is, the two volumes formed by the gyroid minimal surface structure 1402 may be open to each other to facilitate mixing of the fluids 1410, 1412. Having the gyroid minimal surface structure 1402 extend into the inlets 1406 may aid in transitioning and uniformly mixing the fluids 1410, 1412. The mixing chamber 1400 described herein may be used in a number of mixing applications including but not limited to faucets and showerheads.

In certain instances, the gyroid minimal surface structures as described herein may include surface textures that enhance heat transfer between the fluid and the solid. Referring to FIG. 15, which is an isometric view of a gyroid minimal surface structure 1500 with close-up views of the surface texture, the gyroid minimal surface structure 1500 includes surface protrusions 1502 over the gyroid minimal surface structure 1500. The surface protrusions 1502 may be uniformly included or randomly included on the surface. The surface protrusions 1502 may break the laminar flow of a fluid traveling over the gyroid minimal surface structure 1500 and induce transitional/turbulent flow, which increases the heat transfer coefficient near the surface. As seen in the close-up view of the protrusion 1502 of FIG. 15, the protrusion 1502 may be generally shaped like a rectangular prism with a sloped surface 1504, a pair of planar surfaces 1506 on either side of the sloped surface 1504, and a planar surface 1508 with a rounded transition section that merges with the sloped surface 1504.

While the surface texture is described as protrusions 1502 from the surface, other surface features, such as indentations, may be utilized on the gyroid minimal surface structures as described herein without limitation. And while the surface protrusion 1502 is depicted as generally shaped like a rectangular prism, the surface protrusions 1502 may be shaped as according to other designed shapes and patterns such as, for example, semi-hemispherical protrusions or indentations, ridges protruding or indented in the surface, cylindrical protrusions or indentations, etc.

FIGS. 16A and 16B depict a gyroid minimal surface structure 1600 defining a generally cylindrical shape and for fitting within a cylindrical space. FIG. 16A depicts an isometric view of the gyroid minimal surface structure 1600 (outlined by a cylinder in broken line 1604) and FIG. 16B depicts a top view of the gyroid minimal surface structure 1600. Such a gyroid minimal surface structure 1600 could be used in a heat exchanger having a cylindrical housing, for example. As seen in FIGS. 16A and 16B, the gyroid minimal surface structure 1600 includes semi-spherical surface features 1602 such as protrusions that are spaced-apart on thereon. In certain instances, the semi-spherical surface features 1602 may be indentations. And in certain instances, the semi-spherical surface features 1602 may be a combination of protrusions and indentations. These indentations may enhance the heat transfer coefficient at the surface.

The gyroid minimal surface structure and concepts described herein may provide beneficial results to heat exchanger applications because they reduce fouling caused by sharp corners. Since the gyroid minimal surface structures do not include sharp corners, fouling is reduced. Other applications of gyroid minimal surface structures include infill structures to hold structures apart such as in vacuum insulation applications where there are large forces in the normal direction to the walls. Gyroid surfaces may be beneficial to keep the walls supported with minimal cross conduction. Additional applications may include using a gyroid minimal surface structure as a partition wall in a storage tank so as to separate two different fluids in the tank.

While the present disclosure has been described with reference to various implementations, it will be understood that these implementations are illustrative and that the scope of the present disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

In general, while the embodiments described herein have been described with reference to particular embodiments, modifications can be made thereto without departing from the spirit and scope of the disclosure. Note also that the term “including” as used herein is intended to be inclusive, i.e. “including but not limited to.”

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

What is claimed is:

1. A heat exchanger comprising:
an enclosure comprising a first inlet, a first outlet, a second inlet, and a second outlet; and
a minimal surface structure within the enclosure, the minimal surface structure separating a first volume and a second volume within the enclosure,
the first inlet and the first outlet in fluid communication with the first volume, the second inlet and a second outlet in fluid communication with the second volume, the first and second volumes separated from mixing with each other.

2. The heat exchanger of claim 1, wherein the minimal surface structure comprises a triply periodic minimal surface structure.

3. The heat exchanger of claim 1, wherein the minimal surface structure is a gyroid minimal surface structure, and wherein the first and second volumes are oppositely congruent of each other.

4. The heat exchanger of claim 1, wherein the first inlet, first volume, and first outlet are configured to receive a first fluid there through, and the second inlet, second volume, and second outlet are configured to receive a second fluid there through, wherein the minimal surface structure is configured to facilitate heat transfer there through between the first and second fluids.

5. The heat exchanger of claim 1, wherein the minimal surface structure is additively manufactured.

6. The heat exchanger of claim 1, wherein the first inlet, first outlet, second inlet, and second outlet are arranged as a pair of parallel tubes with the minimal surface structure positioned at a midsection thereof.

7. The heat exchanger of claim 6, wherein the pair of parallel tubes comprises a pair of parallel rectangular tubes.

8. The heat exchanger of claim 7, wherein the minimal surface structure is arranged as a rectangular cuboid and positioned such that: a first face of the rectangular cuboid is positioned within the first inlet; a second face of the rectangular cuboid is positioned within the first outlet; a third face of the rectangular cuboid is positioned within the second inlet; and a fourth face of the rectangular cuboid is positioned within the second outlet.

9. The heat exchanger of claim 6, wherein the first inlet and first outlet not coaxially aligned, and wherein the second inlet and the second outlet are not coaxially aligned.

10. The heat exchanger of claim 1, further comprising:
a first baffle positioned at the first inlet and proximate the minimal surface structure, the first baffle comprising first openings permitting fluid flow into the first volume from the first inlet;
a second baffle positioned at the first outlet and proximate the minimal surface structure, the second baffle comprising second openings permitting fluid flow from the first volume to the first outlet;
a third baffle positioned at the second inlet and proximate the minimal surface structure, the third baffle comprising third openings permitting fluid flow into the second volume from the second inlet; and
a fourth baffle positioned at the second outlet and proximate the minimal surface structure, the fourth baffle comprising fourth openings permitting fluid flow from the second volume to the second outlet.

11. The heat exchanger of claim 10, wherein the first baffle further comprises a first wall portion configured to prevent fluid flow from entering the second volume from the first inlet,
wherein the second baffle further comprises a second wall portion configured to prevent fluid flow from exiting the second volume into the first outlet,
wherein the third baffle further comprises a third wall portion configured to prevent fluid flow from entering the first volume from the second inlet, and
wherein the fourth baffle further comprises a fourth wall portion configured to prevent fluid flow from exiting the first volume into the second outlet.

12. The heat exchanger of claim 10, wherein the first baffle, the second baffle, the third baffle, and the fourth baffle are additively manufactured.

13. The heat exchanger of claim 1, wherein the minimal surface structure comprises a surface texture to increase turbulent fluid flow through the first and second volumes.

14. The heat exchanger of claim 13, wherein the surface texture comprises at least one of surface protrusions and surface indentations.

15. A mixing chamber comprising:
an enclosure comprising a first inlet, a second inlet, and a first outlet; and
a minimal surface structure positioned within the enclosure and positioned at least partially within the first inlet, the second inlet, and the second outlet.

16. The mixing chamber of claim 15, wherein the first inlet, second inlet, and first outlet are tubular structures.

17. The mixing chamber of claim 15, wherein the minimal surface structure comprises a Y-shape.

18. The mixing chamber of claim 15, wherein the minimal surface structure comprises a gyroid minimal surface structure.

19. The mixing chamber of claim 18, wherein the gyroid minimal surface structure is additively manufactured.

20. The mixing chamber of claim 15, wherein a first fluid is configured to be received in the first inlet, a second fluid is configured to be received in the second inlet, and the minimal surface structure is configured to facilitate mixing of the first and second fluids.
